(19) United States
(12) Patent Application Publication
(10) Pub. No.: US 2016/0381494 A1
(43) Pub. Date: Dec. 29, 2016

(54) RELAY APPARATUS, COMMUNICATION CONTROL METHOD, AND COMMUNICATION CONTROL SYSTEM

(71) Applicant: Naoto HAMADA, Kanagawa (JP)

(72) Inventor: Naoto HAMADA, Kanagawa (JP)

(73) Assignee: Ricoh Company, Ltd., Tokyo (JP)

(21) Appl. No.: 15/185,283

(22) Filed: Jun. 17, 2016

(30) Foreign Application Priority Data
Jun. 24, 2015 (JP) 2015-126963

(51) Int. Cl. H04W 4/00; H04B 7/155; H04W 48/04; H04W 8/00; H04W 76/02

(52) U.S. Cl. CPC H04W 4/008; H04W 8/005; H04W 76/025; H04W 48/04; H04B 7/15528

(57) ABSTRACT

A relay apparatus that relays communication between an internal network and an external network is provided. The relay apparatus includes a short-range wireless communication unit configured to detect a terminal by establishing short-range wireless communication with the terminal, a first communication unit configured to establish connection with an information processing apparatus that is included in the internal network, a second communication unit configured to establish connection with the external network, and a control unit configured to prohibit communication between the information processing apparatus and the external network while the terminal is being detected by the short-range wireless communication.

### CROSS-REFERENCE TO RELATED APPLICATIONS

The present application is based on and claims priority to Japanese Patent Application No. 2015-126963 filed on Jun. 24, 2015, the entire contents of which are incorporated herein by reference.

### BACKGROUND OF THE INVENTION

1. Field of the Invention

The present invention relates to a relay apparatus, a communication control method, and a communication control system.

2. Description of the Related Art

Techniques are known for remotely accessing a device connected to an internal network from an external network and remotely administering maintenance and the like (see, e.g., Japanese Unexamined Patent Publication No. 2000-155612).

On the other hand, techniques are known for restricting communication from an external network to an internal network using a firewall or the like to ensure information security.

When allowing access to a device connected to an internal network from an external network for purposes of administering maintenance and the like, the risk of confidential information being leaked to the external network cannot be completely eliminated. On the other hand, if access to a device connected to an internal network from an external network is blocked across the board, access made in good faith for purposes of administering maintenance and the like may also be blocked.

### SUMMARY OF THE INVENTION

According to one aspect of the present invention, a technique is provided for allowing access to an internal network from an external network under some circumstances while ensuring information security.

According to one embodiment of the present invention, a relay apparatus that relays communication between an internal network and an external network is provided. The relay apparatus includes a short-range wireless communication unit configured to detect a terminal by establishing short-range wireless communication with the terminal, a first communication unit configured to establish connection with an information processing apparatus that is included in the internal network, a second communication unit configured to establish connection with the external network, and a control unit configured to prohibit communication between the information processing apparatus and the external network while the terminal is being detected by the short-range wireless communication.

### BRIEF DESCRIPTION OF THE DRAWINGS

FIG. 1 is a diagram illustrating a general arrangement of a communication system according to an embodiment of the present invention;

FIG. 2 is a block diagram illustrating an example hardware configuration of a relay apparatus according to an embodiment of the present invention;

FIG. 3 is a block diagram illustrating an example hardware configuration of a terminal according to an embodiment of the present invention;

FIG. 4 is a block diagram illustrating an example hardware configuration of an information processing apparatus according to an embodiment of the present invention;

FIG. 5 is a block diagram illustrating an example hardware configuration of an external apparatus according to an embodiment of the present invention;

FIG. 6 is a block diagram illustrating an example functional configuration of the communication system according to an embodiment of the present invention;

FIG. 7 is a sequence chart illustrating example process operations of the communication system according to an embodiment of the present invention;

FIG. 8 is a diagram illustrating an example display screen that may be displayed on the terminal when a wireless connection is established;

FIG. 9 is a sequence chart illustrating example process operations of the communication system that is configured to prohibit communication with the external apparatus when the terminal transmits data;

FIG. 10 is a table illustrating an example of terminal information managed by a control unit of the relay apparatus according to an embodiment of the present invention;

FIG. 11 is a sequence chart illustrating example process operations of the communication system that is configured to control communication with the external apparatus based on the terminal information;

FIG. 12 is a table illustrating an example of apparatus information managed by the control unit of the relay apparatus according to an embodiment of the present invention;

FIG. 13 is a sequence chart illustrating example process operations of the communication system that is configured to control communication with the external apparatus based on the apparatus information;

FIG. 14 is a diagram illustrating an example display screen that may be displayed on the information processing apparatus that is disconnected from an internal network;

FIG. 15 is a diagram illustrating an example display screen that may be displayed on the terminal when a wireless connection is established;

FIGS. 16A and 16B are diagrams illustrating example display screens that may be displayed by the terminal and the information processing apparatus when communication between the information processing apparatus and an external network has ended and the information processing apparatus has been connected to the internal network; and

FIG. 17 is a diagram illustrating a general arrangement of the communication system that includes a short-range wireless communication apparatus according to an embodiment of the present invention.

### DESCRIPTION OF THE EMBODIMENTS

In the following, embodiments of the present invention are described with reference to the accompanying drawings.

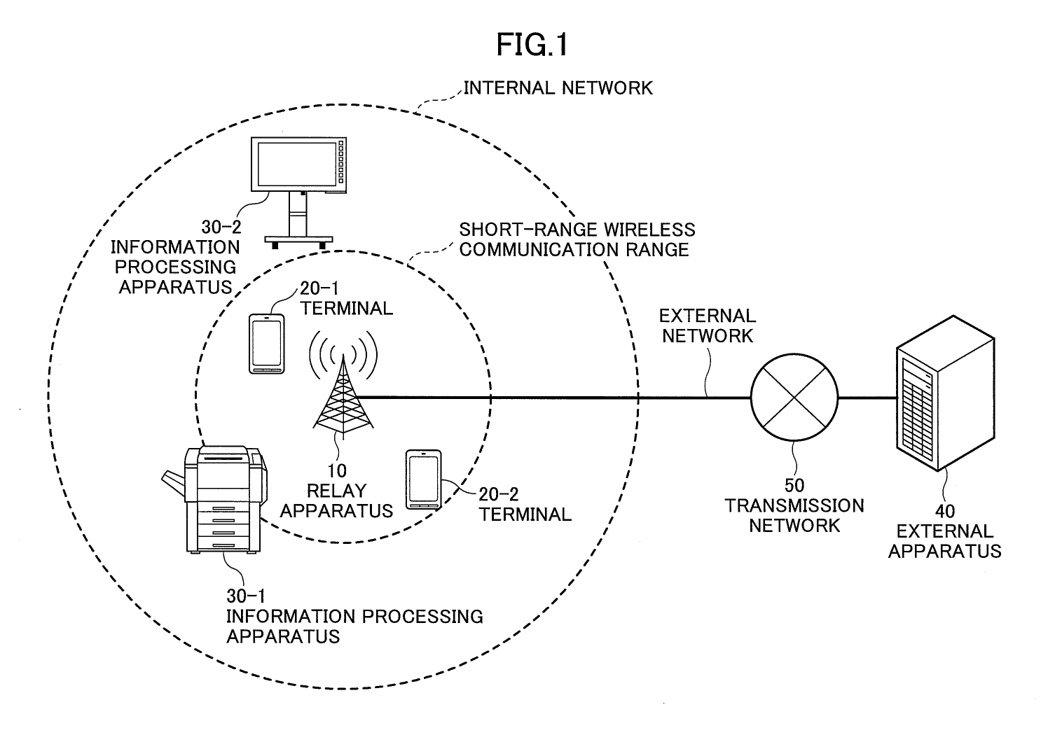

FIG. 1 is a diagram illustrating a general arrangement of a communication system 1 according to an embodiment of the present invention. In FIG. 1, the communication system 1 includes a relay apparatus 10, a plurality of terminals 20-1, 20-2 (generically referred to as “terminal 20” below), a plurality of information processing apparatuses 30-1, 30-2 (generically referred to as “information processing apparatus 30” below), and an external apparatus 40. The relay apparatus 10 may be installed in a conference room or the like where the information processing apparatuses 30 are installed, for example.

The relay apparatus 10 may function as an access point for relaying communication between the terminal 20 and the information processing apparatus 30 via an internal network, for example. Also, the relay apparatus 10 may function as a router or a bridge for establishing communication with the external apparatus 40 via a transmission network 50, which corresponds to an external network, and establish communication between the external apparatus 40 that is connected to the external network and the information processing apparatus 30 that is connected to the internal network. Also, while the relay apparatus 10 detects the terminal 20 by establishing short-range wireless communication with the terminal 20, the relay apparatus 10 prohibits communication between the external network and the information processing apparatus 30 that is connected to the internal network. In this way, the relay apparatus 10 also functions as a communication apparatus that established communication with another apparatus.

The terminal 20 may be a smartphone, a tablet computer, or a notebook PC (personal computer), for example.

The information processing apparatus 30 may be an MFP (Multifunction Peripheral), an IWB (Interactive Whiteboard), or a PC, for example.

The external apparatus 40 may be a PC, for example.

The transmission network 50 may be the Internet, a LAN, or a mobile phone network, for example.

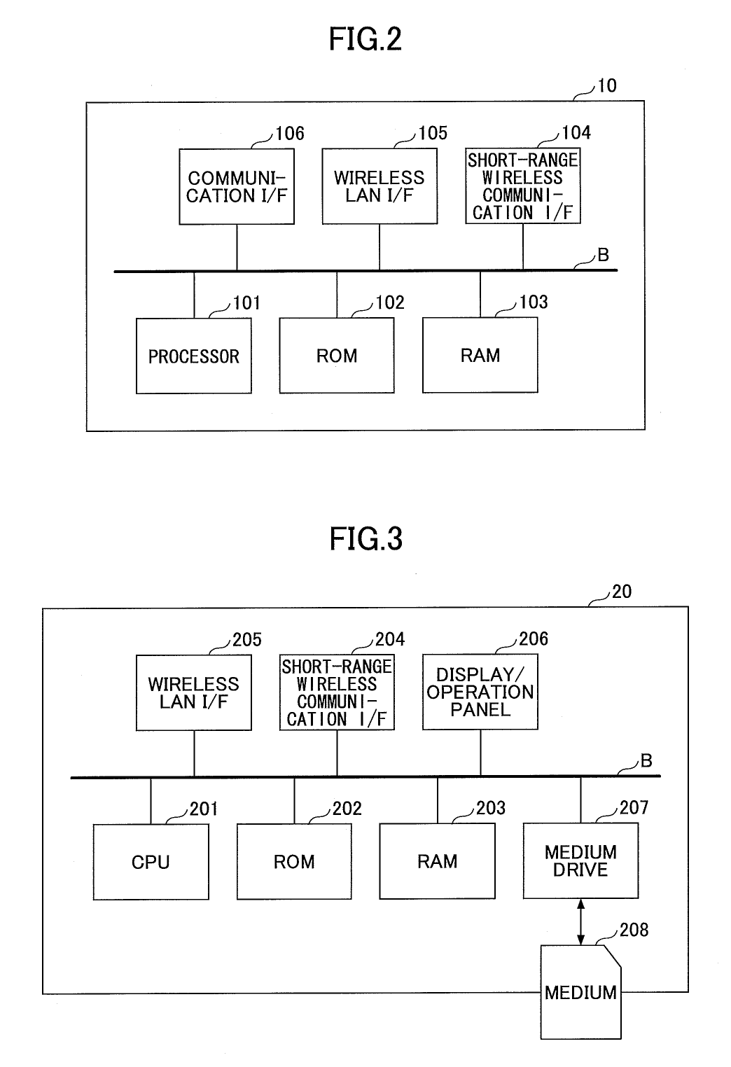

FIG. 2 is a block diagram illustrating an example hardware configuration of the relay apparatus 10 according to an embodiment of the present invention.

The relay apparatus 10 includes a processor 101, a ROM 102, a RAM 103, a short-range wireless interface (I/F) 104, a wireless LAN I/F 105, and a communication I/F 106 that are connected to each other by a bus B.

The processor 101 is a computing unit that reads programs and data stored in a storage device, such as the ROM 102, and loads the programs and data in the RAM 103 to execute processes for controlling and implementing functions of the relay apparatus 10.

The ROM 102 is a nonvolatile semiconductor memory (storage device), such as a flash memory, that is capable of retaining programs and data even when the power is turned off. The ROM 102 may store various programs and data, such as an OS (Operating System) and application programs for implementing various functions, for example.

The RAM 103 is a volatile semiconductor memory (storage device) for temporarily storing programs and data.

The short-range wireless I/F 104 establishes short-range wireless communication using short-range wireless technology, such as BLE (Bluetooth (registered trademark) Low Energy), NFC (Near field communication), or wireless LAN (Local Area Network), for example.

The wireless LAN I/F 105 uses the IEEE 802.11 standard to establish wireless LAN communication.

The communication I/F 106 uses the Ethernet (registered trademark) standard to establish communication.

FIG. 3 is a block diagram illustrating an example hardware configuration of the terminal 20 according to an embodiment of the present invention.

The terminal 20 includes a CPU 201, a ROM 202, a RAM 203, a short-range wireless I/F 204, a wireless LAN I/F 205, a display/operation unit 206, and a medium drive 207 that are connected to each other by a bus B.

The CPU 201 is a computing unit that reads programs and data stored in a storage device, such as the ROM 202, and loads the programs and data in the RAM 203 to execute processes for controlling and implementing functions of the terminal 20.

The ROM 202 is a nonvolatile semiconductor memory (storage device), such as a flash memory, that is capable of retaining programs and data even when the power is turned off. The ROM 202 may store programs and data, such as an OS (Operating System) and application programs for implementing various functions, for example.

The RAM 203 is a volatile semiconductor memory (storage device) for temporarily storing programs and data.

The short-range wireless I/F 204 establishes short-range wireless communication using short-range wireless technology, such as BLE (Bluetooth (registered trademark) Low Energy), NFC (Near field communication), or wireless LAN (Local Area Network), for example.

The wireless LAN I/F 205 uses the IEEE 802.11 standard to establish wireless LAN communication.

The display/operation unit 206 may be implemented by a touch panel having a display function, for example. An operation screen for operating the terminal 20 may be displayed on the display/operation unit 206, for example.

The medium drive 207 controls reading/writing (storage) of data with respect to a recording medium 208 such as a flash memory. The medium drive 207 may be configured to have the recording medium 208 removably loaded therein to retrieve (read) data already stored in the recording medium 208 or newly store (write) data in the recording medium 208.

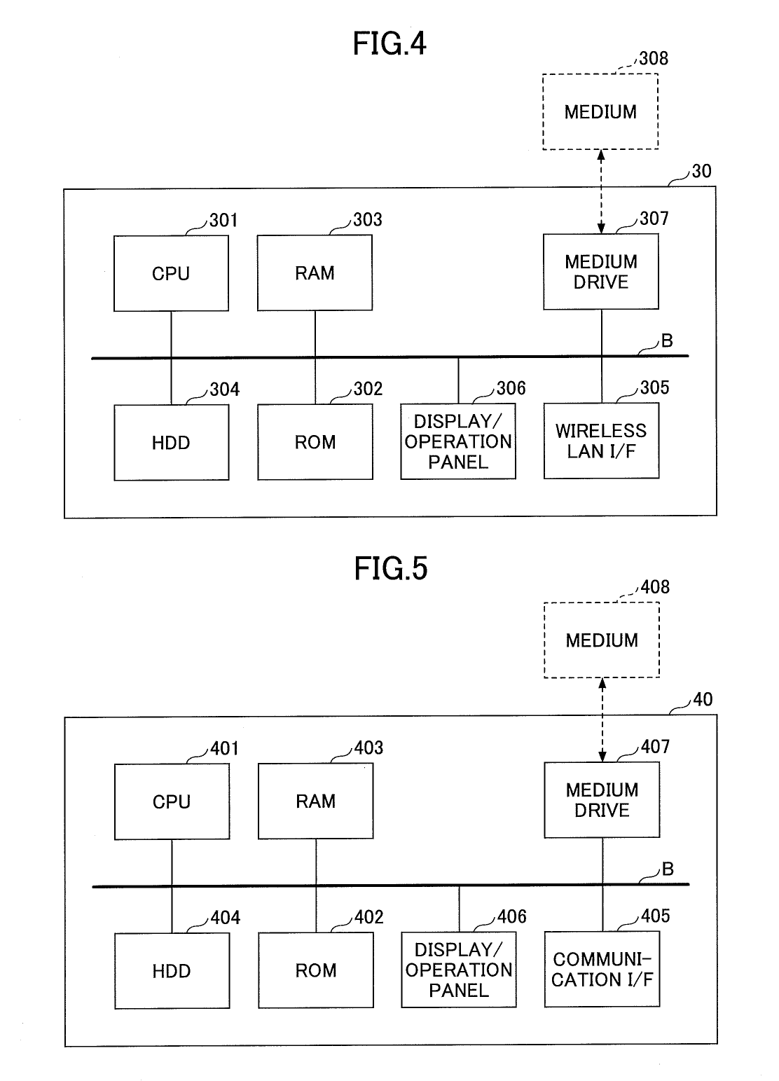

FIG. 4 is a block diagram illustrating an example hardware configuration of the information processing apparatus 30 according to an embodiment of the present invention.

The information processing apparatus 30 includes a CPU 301, a ROM 302, a RAM 303, an HDD (hard disk drive) 304, a wireless LAN I/F 305, a display/operation unit 306, and a medium drive 307 that are connected to each other by a bus B.

The CPU 301 is a computing unit that reads programs and data stored in a storage device, such as the ROM 302, and loads the programs and data in the RAM 303 to execute processes for controlling and implementing functions of the information processing apparatus 30.

The ROM 302 is a nonvolatile semiconductor memory (storage device) that is capable of retaining programs and data even when the power is turned off. The ROM 302 may store programs and data, such as a BIOS (Basic Input/Output System) and OS settings, for example.

The RAM 303 is a volatile semiconductor memory (storage device) for temporarily storing programs and data.

The HDD 304 stores programs and data, such as application programs for implementing various functions, for example.

The wireless LAN I/F 305 uses the IEEE 802.11 standard to establish wireless LAN communication.

The display/operation unit 306 may be implemented by a touch panel having a display function, for example. An operation screen for operating the information processing apparatus 30 may be displayed on the display/operation unit 306, for example.

The medium drive 307 controls reading/writing (storage) of data with respect to a recording medium 308 such as a flash memory. The medium drive 307 may be configured to have the recording medium 308 removably loaded therein to retrieve (read) data already stored in the recording medium 308 or newly store (write) data in the recording medium 308.

FIG. 5 is a block diagram illustrating an example hardware configuration of the external apparatus 40 according to an embodiment of the present invention.

The external apparatus 40 includes a CPU 401, a ROM 402, a RAM 403, an HDD 404, a communication I/F 405, a display/operation unit 406, and a medium drive 407 that are connected to each other by a bus B.

The CPU 401 is a computing unit that reads programs and data from a storage device, such as a the ROM 402, and loads the programs and data in the RAM 403 to execute processes for controlling and implementing functions of the external apparatus 40.

The ROM 402 is a nonvolatile semiconductor memory (storage device) that is capable of retaining programs and data even when the power is turned off. The ROM 402 may store programs and data, such as a BIOS and OS settings, for example.

The RAM 403 is a volatile semiconductor memory (storage device) for temporarily storing programs and data.

The HDD 404 stores programs and data, such as an OS and application programs for implementing various functions, for example.

The communication I/F 405 uses the Ethernet (registered trademark) standard to establish communication.

The display/operation unit 406 may be implemented by a touch panel having a display function, for example. An operation screen for operating the external apparatus 40 may be displayed on the display/operation unit 406, for example.

The medium drive 407 controls reading/writing (storage) of data with respect to a recording medium 408 such as a flash memory. The medium drive 407 may be configured to have the recording medium 308 removably loaded therein to retrieve (read) data already stored in the recording medium 408 or newly store (write) data in the recording medium 308.

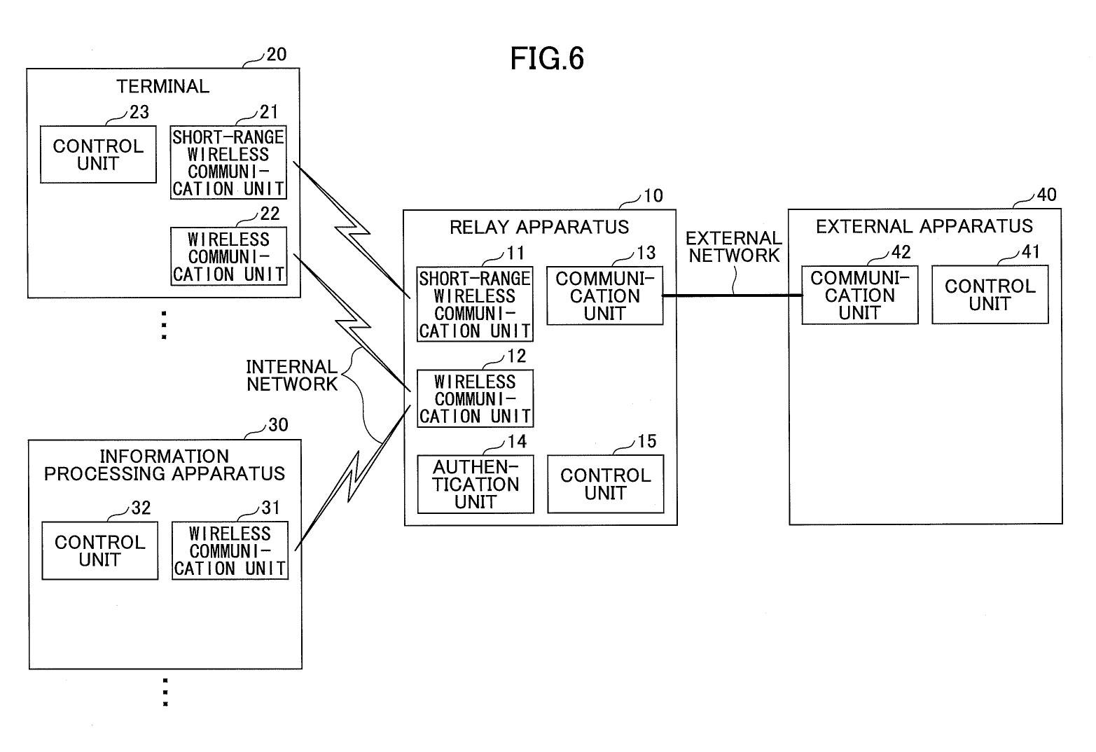

FIG. 6 is a diagram illustrating an example functional configuration of the communication system 1 according to an embodiment of the present invention.

The relay apparatus 10 includes a short-range wireless communication unit 11, a wireless communication unit 12, a communication unit 13, an authentication unit 14, and a control unit 15. These functional elements may be implemented by the processor 101 of the relay apparatus 10 executing one or more programs installed in the relay apparatus 10, for example.

The short-range wireless communication unit 11 controls the short-range wireless I/F 104 to determine whether the terminal 20 is within a short-range wireless communication range using short-range wireless technology, such as BLE, NFC, or wireless LAN, for example. Also, the short-range wireless communication unit 11 sends wireless connection information for establishing wireless communication with the wireless communication unit 12 to the terminal 20 using short-range wireless technology. The wireless connection information may include an SSID (Service Set Identifier) and a password of the wireless communication unit 12, for example.

The wireless communication unit 12 controls the wireless LAN I/F 105 to implement the function of an access point, for example, to thereby establish communication between the terminal 20 and the information processing apparatus 30 using a wireless LAN, for example. Note that in the present description, “internal network” refers to a network to which connection is established via the wireless communication unit 12. The wireless communication unit 12 may be any communication port that is physically separate from the communication unit 13. Note that the wireless communication unit 12 is not limited to establishing communication between the terminal 20 and the information processing apparatus 30 by wireless communication but may be configured to establish communication using a wired LAN cable, for example.

The communication unit 13 controls the communication I/F 106 to implement the function of a router or a bridge, for example, to thereby establish communication with the external apparatus 40 via the transmission network 50. Note that in the present descriptions, “external network” refers to a network to which connection is established via the communication unit 13.

The authentication unit 14 authenticates the terminal 20 that is to be connected to the wireless communication unit 11. For example, the terminal 20 may be successfully authenticated by the authentication unit 14 in a case where identification information such as a MAC (media access control) address of the terminal 20 is registered in the authentication unit 14. Also, the authentication unit 14 authenticates the terminal 20 and the information processing apparatus 30 that are to be connected to the wireless communication unit 12. The authentication unit 14 may perform the authentication using an SSID and a password, for example.

The control unit 15 prohibits communication between the external network and the information processing apparatus 30 that is connected to the internal network while the short-range wireless communication unit 11 detects the terminal 20 that has been authenticated by the authentication unit 14.

When the short-range wireless communication unit 11 no longer detects the terminal 20, the control unit 15 transmits a deletion request to the information processing apparatus 30 that is connected to the internal network to delete confidential information generated at the information processing apparatus 30. Note that in the present description, “confidential information” refers to information generated at the information processing apparatus 30 while the terminal 20 is detected by short-range wireless communication. For example, confidential information may include data received from the terminal 20 or input by a user, such as print data to be printed by a printer or display data to be displayed by an IWB.

The control unit 15 allows communication between the internal network and the external network when it receives a deletion completion notification indicating that confidential information has been deleted at the information processing apparatus 30.

The terminal 20 includes a short-range wireless communication unit 21, a wireless communication unit 22, and a control unit 23. These functional elements may be implemented by the CPU 201 of the terminal 20 executing relevant processes based on one or more programs that are installed in the terminal 20.

The short-range wireless communication unit 21 controls the short-range wireless I/F 204 to establish communication with the wireless communication unit 11 of the relay apparatus 10 using short-range wireless technology, such as BLE or NFC, for example.

The wireless communication unit 22 controls the wireless LAN I/F 205 to establish communication with the wireless communication unit 12 of the relay apparatus 10 using a wireless LAN, for example.

The control unit 23 establishes connection with the relay apparatus 10 via the wireless communication unit 22, based on wireless connection information that is transmitted from the relay apparatus 10 and received by the short-range wireless communication unit 21. The control unit 23 also displays predetermined information received from the relay apparatus 10 on a display screen.

The information processing apparatus 30 includes a wireless communication unit 31 and a control unit 32.

The wireless communication unit 31 controls the wireless LAN I/F 305 using a wireless LAN, for example, to establish communication with the wireless communication unit 12 of the relay apparatus 10.

The control unit 32 executes processes, such as printing or display of data, based on a process request from the external apparatus 40 or the terminal 20, for example. The control unit 32 also deletes confidential information, such as data printed by a printer or data displayed by an IWB, in response to a deletion request from the relay apparatus 20.

The external apparatus 40 includes a communication unit 41 and a control unit 42.

The communication unit 41 controls the communication I/F 405 to establish communication with the communication unit 13 of the relay apparatus 10 via the transmission network 50.

The control unit 42 accesses the information processing apparatus 30 via the relay apparatus 10, and requests the information processing apparatus 30 to execute a process, such as updating an OS, firmware, or an application program installed in the information processing apparatus 30, or executing a print job, for example.

### First Embodiment

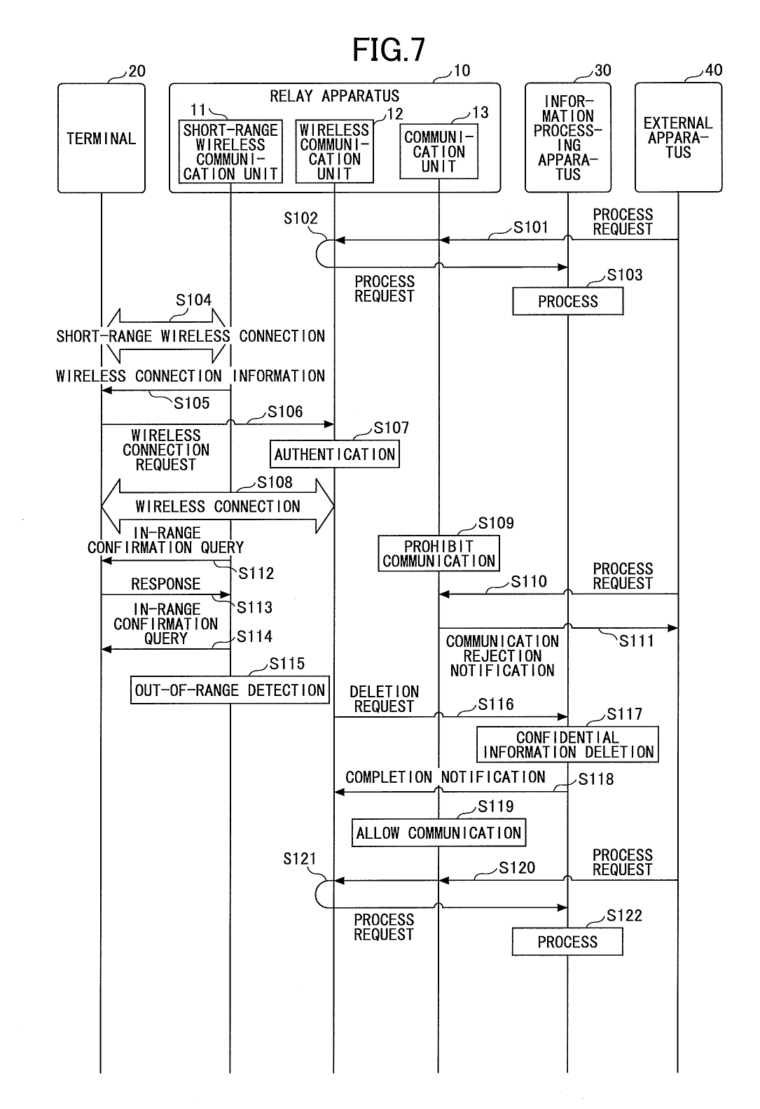

In the following, process operations of the communication system 1 according to a first embodiment of the present invention are described with reference to FIG. 7.

In the first embodiment, the relay apparatus 10 prohibits communication between the external network and the information processing apparatus 30 that is connected to the internal network while the relay apparatus 10 detects the terminal 20 by short-range wireless communication. In this way, the external network may be allowed to access the internal network under certain circumstances while ensuring information security. Note that in the example described below, the terminal 20 is detected through short-range wireless communication. However, the device to be detected through short-range communication in the present embodiment is not limited to the terminal 20, but may be some other electronic device (e.g. a projector or a camera) having functions similar to those of the terminal 20.

FIG. 7 is a sequence chart illustrating example process operations of the communication system 1 according to the first embodiment.

First, the external apparatus 40 transmits to the relay device 10 a process request addressed to the information processing apparatus 30 (step S101). When the terminal 20 is not within the communication range of the short-range wireless communication unit 11, the relay apparatus 10 allows communication between the external apparatus 40 and the information processing apparatus 30. That is, the process request from the external apparatus 40 that is received by the communication unit 13 is forwarded to the information processing apparatus 30 via and the wireless communication unit 12 (step S102). In turn, the information processing apparatus 30 executes a predetermined process based on the received process request (step S103).

When the terminal 20 is turned on or is moved, for example, to be within the communication range of the short-range wireless communication unit 11 of the relay apparatus 10, the terminal 20 is authenticated by the authentication unit 14, and thereafter, short-range wireless communication is established between the short-range wireless communication unit 11 and the terminal 20 (step S104).

The short-range wireless communication unit 11 transmits wireless connection information to the terminal 20 (step S105). The wireless connection information includes information for establishing wireless communication with the wireless communication unit 12 of the relay apparatus 10. The wireless connection information may include an SSID and a password, for example. The terminal 20 transmits a wireless connection request including the received wireless connection information to the wireless communication unit 12 (step S106). The wireless communication unit 12 performs authentication based on the wireless connection information included in the received wireless connection request (step S107). If the authentication is successful, the control unit 15 establishes wireless communication between the terminal 20 and the wireless communication unit 12 (step S108), and controls the communication unit 13 to prohibit communication with the external network (step S109). Note that at this time, the control unit 15 may control the wireless communication unit 12 to transmit a notification to the terminal 20 indicating that the wireless communication has been established and communication with the external network has been prohibited, and control the terminal 20 to display such a notification on a display screen, for example.

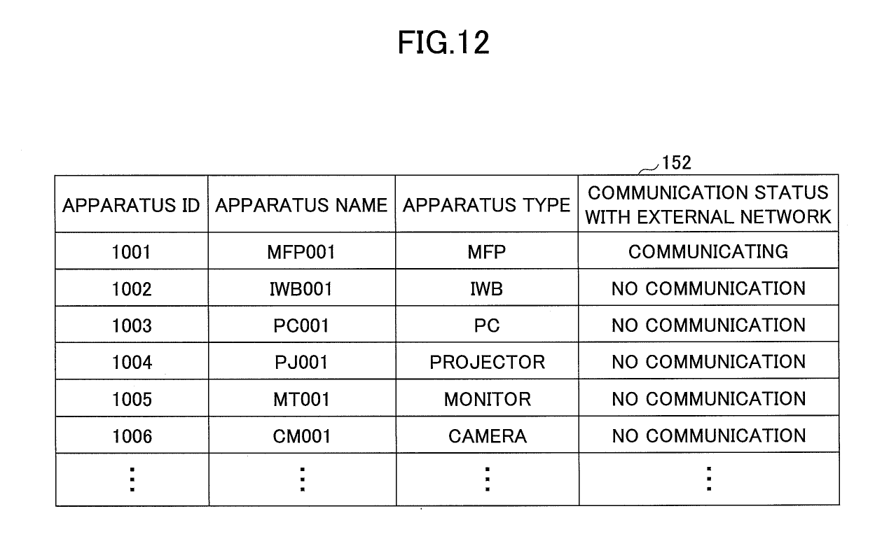

Note that in some embodiments, the relay apparatus 10 may have apparatus information relating to apparatuses connected to the internal network stored in advance (see, e.g., FIG. 12), and when wireless communication with an apparatus (terminal 20 in the present example) that is not included in the stored apparatus information is established, the relay apparatus 10 may decide to prohibit communication with the external network, for example. Also, in some embodiments, the relay apparatus 10 may prohibit communication with the external network while short-range wireless communication is established between the relay apparatus 10 and the terminal 20 (step S104 in the present example), for example.

When the external apparatus 40 transmits a process request to the information processing apparatus 30 while the communication with the external network is prohibited (step S110), the communication unit 13 transmits a communication rejection notification to the external apparatus 40 (step S111).

While short-range wireless communication is established between the terminal 20 and the relay apparatus 10, the short-range wireless communication unit 11 periodically requests the terminal 20 to return a response to an in-range confirmation query (step S112). The terminal 20 returns a response to the in-range confirmation query (step S113). The short-range wireless communication unit 11 continues to periodically request the terminal 20 to return a response to the in-range confirmation query (step S114), and if a response has not been returned by the terminal 20 for at least a predetermined time period, the short-range wireless communication unit 11 determines that the terminal 20 is no longer within the communication range of the short-range wireless communication unit 11 (step S115). Then, the control unit 15 controls the wireless communication unit 12 to transmit a confidential information deletion request to the information processing apparatus 30 (step S116). In turn, the information processing apparatus 30 deletes the confidential information (step S117), and after completing the deletion process, transmits a completion notification to the wireless communication unit 12 (step S118).

Then, the control unit 15 controls the communication unit 13 to allow communication with the external apparatus 40 (step S119). When the external apparatus 40 transmits a process request to the information processing apparatus 30 while communication between the information processing apparatus 30 and the external apparatus 40 is allowed (step S120), the relay apparatus 10 receives the process request and forwards the received process request to the information processing apparatus 30 (step S121). In turn, the information processing apparatus 30 executes a predetermined process based on the received process request (step S122).

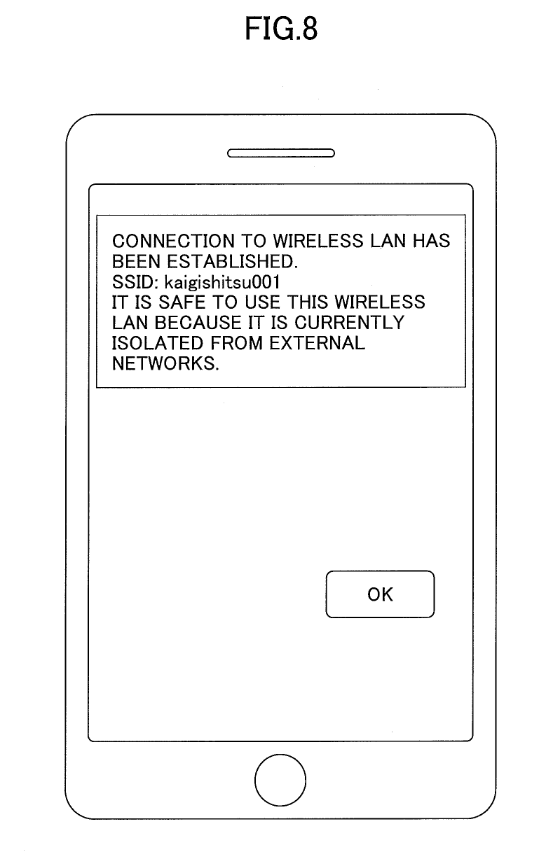

In the following, referring to FIG. 8, an example display screen that may be displayed by the terminal 20 when wireless communication is established between the terminal 20 and the relay apparatus 10 and communication with the external network is prohibited in steps S108 and S109 of FIG. 7 is described. Such a display screen may be displayed based on a notification transmitted from the relay apparatus 10, for example.

FIG. 8 illustrates an example of the display screen that may be displayed by the terminal 20 when wireless communication between the terminal 20 and the relay apparatus 10 is established according to the first embodiment. The relay apparatus 10 may transmit a notification to the terminal 20 including the SSID of the wireless network to which connection has been established and a message indicating that communication with the external network via the communication unit 13 is prohibited, and the relay apparatus 10 may control the terminal 20 to display the display screen as illustrated in FIG. 8, for example.

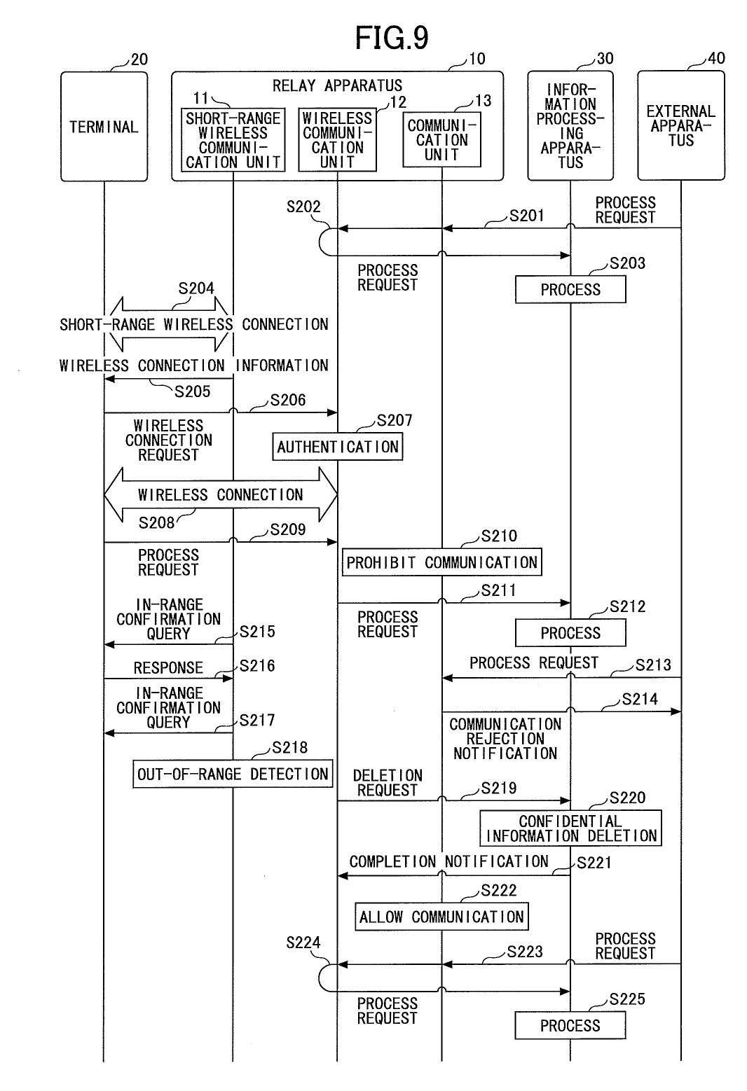

Note that in some embodiments, the process of step S109 in which the control unit 15 controls the communication unit 13 to prohibit communication with the external network may be executed at the time short-range wireless communication with the terminal 20 is established in step S104 rather than when wireless communication with the terminal 20 is established in step S108, for example. In other embodiments, as described below with reference to FIG. 9, communication with the external network may be prohibited at the time the terminal 20 transmits data, such as print data or display data, to the information processing apparatus 30 via the wireless communication unit 12 of the relay apparatus 10, for example. In this case, the external apparatus 40 may be allowed to access the information processing apparatus 30 until the terminal 20 transmits confidential information to the information processing apparatus 30.

FIG. 9 is a sequence chart illustrating example process operations of the communication system 1 that is configured to prohibit communication with the external network when the terminal 20 transmits data to the information processing apparatus 30.

In FIG. 9, the external apparatus 40 is allowed to access the information processing apparatus 30 via the relay apparatus 10 while the relay apparatus 10 executes the processes of establishing short-range wireless communication with the terminal 20 and subsequently establishing wireless communication with the terminal 20. Note that steps S201 to S208 of FIG. 9 are substantially identical to the processes of steps S101 to S108 of FIG. 7, and as such, detailed descriptions thereof are omitted. Note that in some embodiments, when wireless communication with the terminal 20 is established in step S208, the control unit 15 may control the wireless communication unit 12 to transmit a notification to the terminal 20 indicating that the wireless communication has been established and control the terminal 20 to display such notification on a display screen, for example.

The terminal 20 transmits to the relay apparatus 10 a process request including data, such as print data or display data, addressed to the information processing apparatus 30 (step S209). The control unit 15 of the relay apparatus 10 controls the communication unit 13 to prohibit communication with the external network (step S210). Note that at this time, the control unit 15 may control the wireless communication unit 12 to transmit a notification to the terminal 20 indicating that communication with the external network has been prohibited and control the terminal 20 to display such notification on a display screen, for example.

The wireless communication unit 12 of the relay apparatus 10 receives the process request from the terminal 20 and forwards the received process request to the information processing apparatus 30 (step S211). In turn, the information processing apparatus 30 executes a predetermined process based on the received process request (step S212). Thereafter, in steps S213 to S224, the relay apparatus 10 executes the processes of detecting whether the terminal 20 is within the communication range of the short-range wireless communication unit 11, requesting the information processing apparatus 30 to delete confidential information when the terminal 20 no longer detected by the short-range wireless communication, and allow the external apparatus 40 to access the information processing apparatus 30. Note that the processes of steps S213 to S225 of FIG. 9 are substantially identical to the processes of steps S110 to S122 of FIG. 7, and as such, detailed descriptions thereof are omitted.

In the process operations according to the first embodiment as described above, access from the external network to an internal network may be allowed to under certain circumstances while ensuring information security, for example.

### Second Embodiment

In the following, process operations of the communication system 1 according to a second embodiment of the present invention are described. In the second embodiment, the relay apparatus 10 manages terminal information of a plurality of terminals 20 that are detected within the communication range of the short-range wireless communication unit 11, and determines whether to allow or prohibit communication with the external network via the communication unit 13 based on the terminal information managed by the relay apparatus 10. In this way, whether to allow or prohibit communication with the external network may be more aptly controlled, for example.

The control unit 15 of the relay apparatus 10 according to the second embodiment manages terminal information 151 relating to a plurality of terminals 20 detected within the communication range of the wireless communication unit 11.

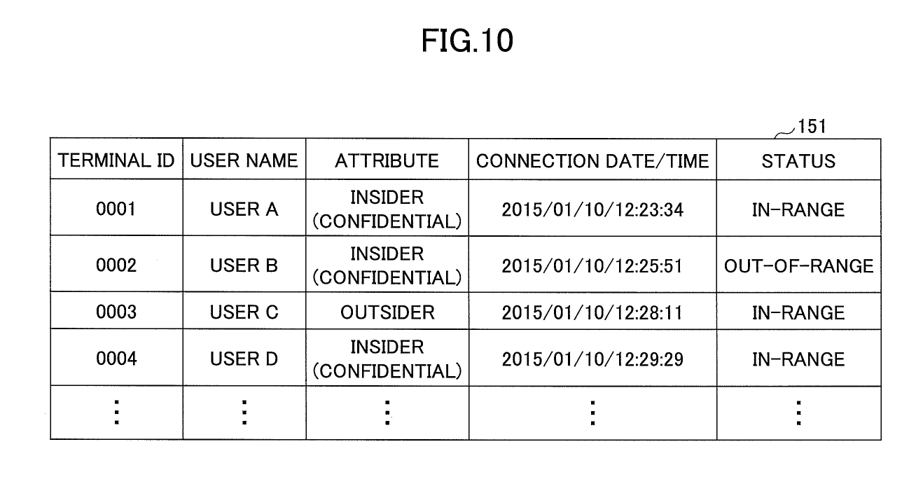

FIG. 10 is a table illustrating an example of the terminal information 151 managed by the control unit 15 of the relay apparatus 10 according to the second embodiment.

In FIG. 10, the terminal information 151 includes information items, such as terminal ID, user name, attribute, connection date/time, and status.

The terminal ID is information for identifying the terminal 20 and may be the MAC address of the terminal 20, for example. The user name is information indicating the name of the user using the terminal 20. Attribute is information indicating an attribute relating to confidential information held by the terminal 20 or the user using the terminal 20. For example, the attribute may be information indicating whether the user of the terminal 20 is an insider having knowledge of confidential information, such as an employee or a developer. The connection date/time is information indicating the date and time short-range wireless communication has been established between the wireless communication unit 11 and the terminal 20. The status is information indicating whether the terminal 20 is within the communication range of the short-range wireless communication unit 11.

Note that the user name and the attribute associated with the terminal 20 may be obtained from the terminal 20 via the wireless communication unit 11 or the wireless communication unit 12, for example, or these information items may be stored in advance in association with the terminal ID of the terminal 20, for example.

The control unit 15 of the relay apparatus 10 according to the second embodiment controls whether to allow or prohibit communication with the external network via the communication unit 13 based on the terminal information 151.

For example, the control unit 15 may control whether to allow or prohibit communication with the external network based on the number of terminals 20 included in the terminal information 151 that have statuses indicated as “in-range” of the short-range wireless communication unit 11.

When the number of terminals 20 that is “in-range” changes from 0 to 1; namely, when a first terminal 20-1 of the plurality of terminals 20 enters the short-range wireless communication range of the relay apparatus 10, confidential information still unlikely to be input to an MFP or an IWB, for example. Thus, the control unit 15 does not prohibit communication with the external network at this time. On the other hand, when the number of terminals 20 that is “in-range” changes from 1 to 2; namely, when a second terminal 20-2 of the plurality of terminals 20 enters the short-range wireless communication range of the relay apparatus 10, the control unit 15 prohibits communication with the external network.

Also, when there is no longer any terminal 20 within the short-range wireless communication range of the relay apparatus 10, the control unit 15 may determine that the terminals 20 have finished using the information processing apparatus 30 and request the information processing apparatus 30 to delete confidential information. Then, after the confidential information is deleted, the control unit 15 may allow communication with the external apparatus 40.

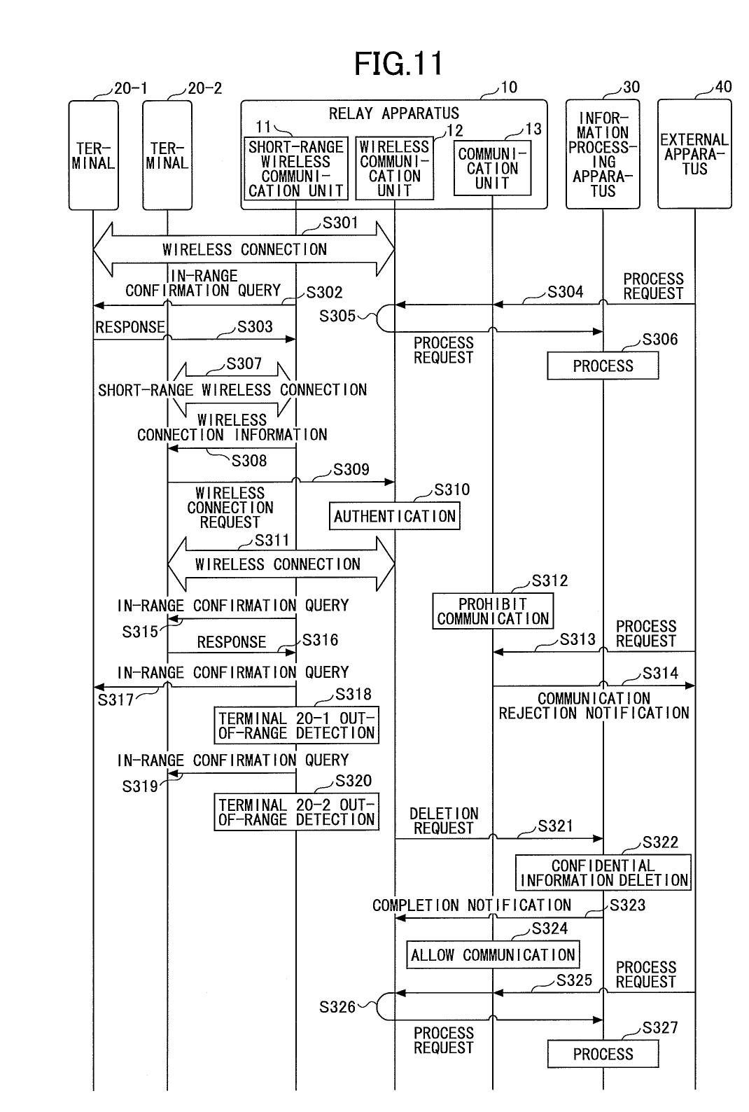

In the following, process operations of the communication system 1 according to the second embodiment are described with reference to FIG. 11. FIG. 11 is a sequence chart illustrating example process operations of the communication system 1 according to the second embodiment.

First, after establishing short-range wireless communication with the short-range wireless communication unit 11 of the relay apparatus 10, the terminal 20-1 establishes wireless communication with the wireless communication unit 12 (step S301). While the short-range wireless communication is established between the terminal 20-1 and the relay apparatus 10, the short-range wireless communication unit 11 periodically requests the terminal 20-1 to return a response to an in-range confirmation query (step S302). The terminal 20-1 returns a response to the in-range confirmation query (step S303).

When the external apparatus 40 transmits a process request to the information processing apparatus 30 while the relay apparatus 10 is only wirelessly connected to the terminal 20-1 (step S304), the relay apparatus 10 allows the external apparatus 40 to access the information processing apparatus 30 (step S305) such that the information processing apparatus 30 may execute a predetermined process based on the process request (step S306). In steps S307 to S316, the second terminal 20-2 establishes short-range wireless communication with the relay apparatus 10 and subsequently establishes wireless communication with the wireless communication unit 12, after which the control unit 15 prohibits communication with the external network via the communication unit 13. Note that the processes of steps S304 to S316 of FIG. 11 are substantially identical to the processes of steps S101 to S113 of FIG. 7, and as such, detailed descriptions thereof are omitted.

Note that in step S312 where the control unit 15 prohibits communication with the external network via the communication unit 13, the control unit 15 may also control the wireless communication unit 12 to transmit a notification to the terminals 20-1 and 20-2 indicating that communication with the external network has been prohibited and control the terminals 20-1 and 20-2 to display such notification on their display screens, for example.

The short-range wireless communication unit 11 continues to periodically request the terminal 20-1 to return a response to the in-range confirmation query (step S317), and if a response from the terminal 20-1 is not returned for a predetermined time period, it is determined that the terminal 20-1 is no longer within the communication range of the short-range wireless communication unit 11 (step S318).

Similarly, the short-range wireless communication unit 11 continues to periodically request the terminal 20-2 to return a response to the in-range confirmation query (step S319), and if a response from the terminal 20-2 is not returned for a predetermined time period, it is determined that the terminal 20-2 is no longer within the communication range of the short-range wireless communication unit 11 (step S320).

Then, the control unit 15 determines that there is no longer any terminal 20 within the short-range wireless communication range of the relay apparatus 10, and controls the wireless communication unit 12 to transmit a deletion request to the information processing apparatus 30 to delete confidential information (step S321).

Then, in steps S322 to S327, confidential information held by the information processing apparatus 30 is deleted, and communication with the external apparatus 40 is allowed. Note that the processes of steps S322 to S327 of FIG. 11 are substantially identical to the processes of steps S117 to S122 of FIG. 7, and as such, detailed descriptions thereof are omitted.

Note that in some embodiments, when the number of terminals 20 that is “in-range” changes from 0 to 1, the control unit 15 may check the attribute associated with the terminal 20 included in the terminal information 151 whose status has been changed to “in-range”, and if the relevant attribute indicates that the user of the terminal 20 is not a user having knowledge of confidential information (e.g. “outsider”), the control unit 15 may not prohibit communication with the external network, for example. In this way, if the possibility of confidential information being input to an MFP or an IWB is relatively low, the control unit 15 may allow communication with the external network.

In other embodiments, the control unit 15 may refer to the connection date/time stored in association with the terminal 20 in the terminal information 151, and if the connection date/time associated with the terminal 20 is at least a certain time period earlier than the current date/time, the control unit 15 may assume that the terminal 20 is “out-of-range” for establishing short-range wireless communication with the relay apparatus 11, for example. In this way, when the terminal 20 is left behind in a conference room, for example, communication between the external apparatus 40 and the information processing apparatus 30 may be prevented from being prohibited for an unnecessarily long period of time.

In the process operations according to the second embodiment as described above, whether to allow or prohibit communication with the external network is determined based on information relating to the terminals 20 detected by the short-range wireless communication unit 11, and in this way, whether to allow or prohibit communication with the external network may be more aptly controlled, for example.

### Third Embodiment

In the following, process operations of the communication system 1 according to a third embodiment of the present invention are described. In the third embodiment, the relay apparatus 10 manages apparatus information relating to a plurality of information processing apparatuses 30 that are connected to the wireless communication unit 12, and determines whether to allow or prohibit communication with the external network via the communication unit 13 based on the apparatus information managed by the relay apparatus 10. In this way, whether to allow or prohibit communication with the external network may be more aptly controlled, for example.

The control unit 15 of the relay apparatus 10 according to the third embodiment manages apparatus information 152 relating to a plurality of information processing apparatuses 30 that are connected to the wireless communication unit 12.

FIG. 12 is a table illustrating an example of the apparatus information 152 managed by the control unit 15 of the relay apparatus 10 according to the third embodiment.

In FIG. 12, the apparatus information 152 includes information items, such as apparatus ID, apparatus name, apparatus type, and communication status with external network.

The apparatus ID is information for identifying the information processing apparatus 30 and may be an IP address or a MAC address of the information processing apparatus 30, for example. The apparatus name is information indicating the name of the information processing apparatus 30. The apparatus type is information indicating the type of the information processing apparatus 30, such as an MFP, a projector, an IWB, a monitor, or a camera, for example. The communication status with external network is information indicating whether the information processing apparatus 30 is communicating with the external apparatus 40 via the communication unit 13.

Note that the apparatus name and the apparatus type of the information processing apparatus 30 may be obtained from the information processing apparatus 30 via the wireless communication unit 12, or these information items may be stored in advance in association with the apparatus ID of the information processing apparatus 30, for example.

The communication status of the information processing apparatus 30 with the external network may be obtained by making a query to the information processing apparatus 30 using the wireless communication unit 12, or the communication status may be determined based on a packet transmitted/received by the communication unit 13. In the case of determining the communication status based on a packet transmitted/received by the communication unit 13, for example, the control unit 15 may monitor a packet designating the IP address of the external apparatus 40 as the sender and the IP address of the information processing apparatus 30 as the destination, or the control unit 15 may monitor a packet designating the IP address of the external apparatus 40 as the destination and designating the IP address of the information processing apparatus 30 as the sender. If a predetermined time period has not yet elapsed from the time the monitored packet has been transmitted/received, the control unit 15 may determine that the information processing apparatus 30 is “communicating” with the external network, for example.

The control unit 15 of the relay apparatus 10 according to the third embodiment controls whether to allow or prohibit communication with the external network via the communication unit 13 based on information stored in the apparatus information 152.

For example, when the short-range wireless communication unit 11 detects the terminal 20 by short-range wireless communication, the control unit 15 may check the communication status stored in the apparatus information 152, and if the apparatus information 152 indicates that the information processing apparatus 30-1 is “communicating” with the external network, the control unit 15 disconnects the information processing apparatus 30-1 from the internal network. That is, the control unit 15 allows communication between the information processing apparatus 30-1 and the external apparatus 40, but prohibits communication between the information processing apparatus 30-1 and the other information processing apparatuses 30 (e.g., information processing apparatus 30-2) and the terminal 20. Note that communication between the information processing apparatus 30-1 and the external apparatus 40 may be allowed by enabling communication between the IP address of the information processing apparatus 30-1 and the transmission network 50 connected to the communication unit 13, or enabling communication between the IP address of the information processing apparatus 30-1 and the IP address of the external apparatus 40, for example.

When the control unit 15 detects that the communication status of the information processing apparatus 30-1 with the external network has changed from “communicating” to “no communication”, the control unit 15 prohibits communication between the information processing apparatus 30-1 and the external apparatus 40 and allows communication between the information processing apparatus 30-1 and the other information processing apparatuses 30 (e.g., information processing apparatus 30-2) and the terminal 20.

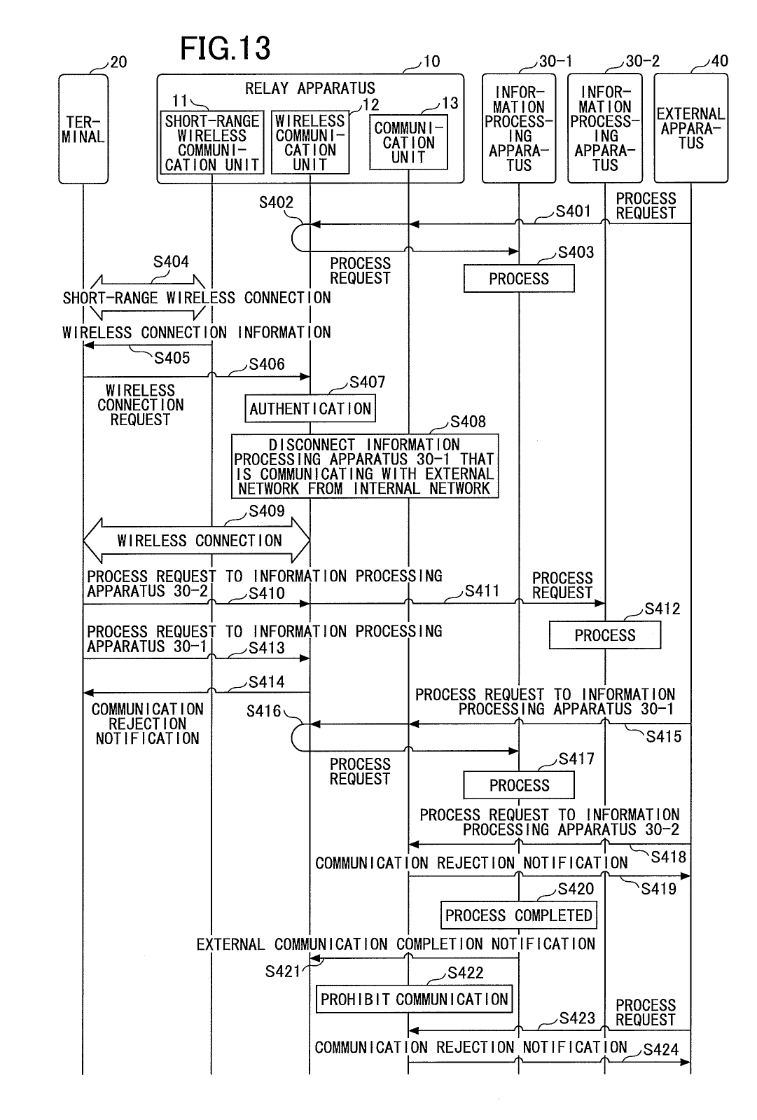

In the following, example process operations of the communication system 1 according to the third embodiment are described with reference to FIG. 13. FIG. 13 is a sequence chart illustrating example process operations of the communication system 1 according to the third embodiment.

The external apparatus 40 is allowed to access the information processing apparatuses 30-1 (steps S401-S403) while the relay apparatus 10 establishes short-range wireless communication with the terminal 20 and authenticates the relay apparatus 10 via the authentication unit 14 (steps S404-S407). Note that the processes of steps S401 to S407 of FIG. 13 are substantially identical to the processes of steps S101 to S107 of FIG. 7, and as such, detailed descriptions thereof are omitted.

Based on the apparatus information 152, the control unit 15 may determine that the information processing apparatus 30-1 is communicating with the external apparatus 40 and thereby disconnect the information processing apparatus 30-1 from the internal network (step S408). Note that at this time, the control unit 15 may control the wireless communication unit 12 to transmit a notification to the information processing apparatus 30-1 indicating that the information processing apparatus 30-1 is being disconnected from the internal network because it is in communication with the external apparatus 40 and control the information processing apparatus 30-1 to display such notification on a display screen, for example.

Then, the wireless communication unit 12 establishes wireless communication with the terminal 20 (step S409). Note that at this time, the control unit 15 may control the wireless communication unit 12 to transmit a notification to the terminal 20 indicating that the wireless communication has been established, and indicating the information processing apparatus 30-2 that can be accessed via the internal network and the information processing apparatus 30-1 that is disconnected from the internal network and cannot be accessed via the internal network, for example. The control unit 15 may further control the terminal 20 to display such notification on a display screen, for example.

When the terminal 20 transmits to the wireless communication unit 12 a process request addressed to the information processing apparatus 30-2 (step S410), the wireless communication unit 12 receives the process request and forwards the received process request to the information processing apparatus 30-2 (step S411), and the information processing apparatus 30-2 executes the requested process (step S412).

When the terminal 20 transmits to the wireless communication unit 12 a process request addressed to the information processing apparatus 30-1 (step S413), the wireless communication unit 12 transmits a communication rejection notification to the terminal 20 (step S414).

When the external apparatus 40 transmits to the wireless communication unit 12 a process request addressed to the information processing apparatus 30-1 (step S415), the wireless communication unit 12 receives the process request and forwards the received process request to the information processing apparatus 30-1 (step S416), and the information processing apparatus 30-1 executes the requested process (step S417).

When the external apparatus 40 transmits to the wireless communication unit 12 a process request addressed to the information processing apparatus 30-2 (step S418), the wireless communication unit 12 transmits a communication rejection notification to the external apparatus 40 (step S419).

When the information processing apparatus 30-1 completes execution of the process requested by the process request from the external apparatus 40 (step S420), the information processing apparatus 30-1 transmits a notification to the wireless communication unit 12 indicating that communication with the external network has ended (step S421).

In turn, the control unit 15 updates the communication status of the information processing apparatus 30-1 with the external network stored in the apparatus information 152 from “communicating” to “no communication”. Also, the control unit 15 controls the communication unit 13 to prohibit communication between the external apparatus 40 and the information processing apparatus 30-1, and controls the wireless communication unit 12 to allow communication between the information processing apparatus 30-1 and the terminal 20 (step S422). Note that at this time, the control unit 15 may also control the wireless communication unit 12 to transmit a notification to the terminal 20 and the information processing apparatus 30-1 indicating that communication between the external apparatus 40 and the information processing apparatus 30-1 is being prohibited and that communication between the terminal 20 and the information processing apparatus 30-1 is being allowed, and control the terminal 20 and the information processing apparatus 30-1 to display such notification on their display screens, for example.

Thereafter, when the external apparatus 40 transmits to the wireless communication unit 12 a process request addressed to the information processing apparatus 30-1 or the information processing apparatus 30-2 (step S423), the wireless communication unit 12 transmits a communication rejection notification to the external apparatus 40 (step S424).

Note that in some embodiments, the control unit 15 may control communication with the external apparatus based on information on the apparatus type stored in the apparatus information 152. For example, if the apparatus information 152 includes a plurality of information processing apparatuses 30 with the apparatus type indicated as “MFP”, and the communication status of at least one of these information processing apparatuses 30 and the external network is indicated as “no communication”, the control unit 15 may control the wireless communication unit 12 to disconnect the other information processing apparatuses 30 that are indicated as “communicating” with the external network. In this way, at least one “MFP” may remain connected to the internal network and be readily used via the internal network, for example.

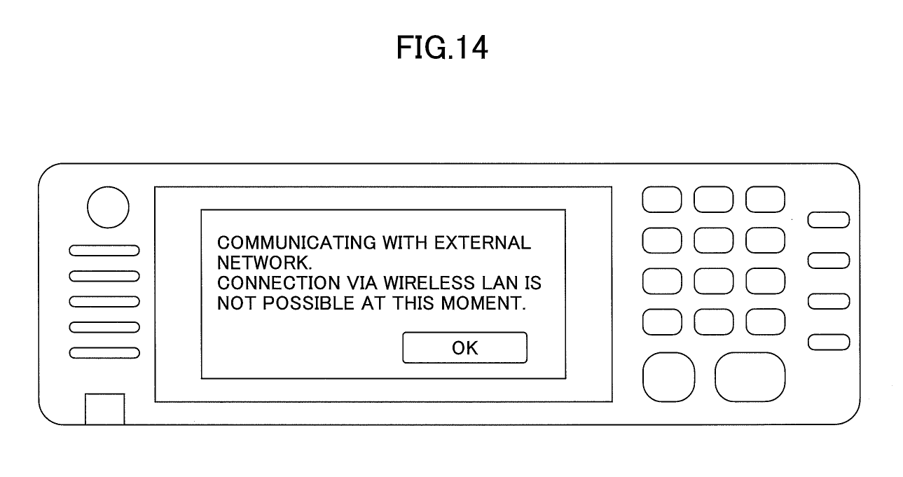

In the following, referring to FIG. 14, a display screen that may be displayed by the information processing apparatus 30-1 when the information processing apparatus 30-1 is disconnected from the internal network in in step S408 of FIG. 13 is described. Such a display screen may be displayed by the information processing apparatus 30-1 based on a notification from the relay apparatus 10 that is transmitted when the control unit 15 determines that the information processing apparatus 30-1 is communicating with the external apparatus 40 and thereby disconnects the information processing apparatus 30-1 from the internal network.

FIG. 14 illustrates an example display screen that may be displayed by the information processing apparatus 30-1 that has been disconnected from the internal network. The relay apparatus 10 may transmit to the information processing apparatus 30-1 a message indicating that the information processing apparatus 30-1 has been disconnected from the internal network because it is communicating with the external apparatus 40, and control the information processing apparatus 30-1 to display the display screen of FIG. 14, for example.

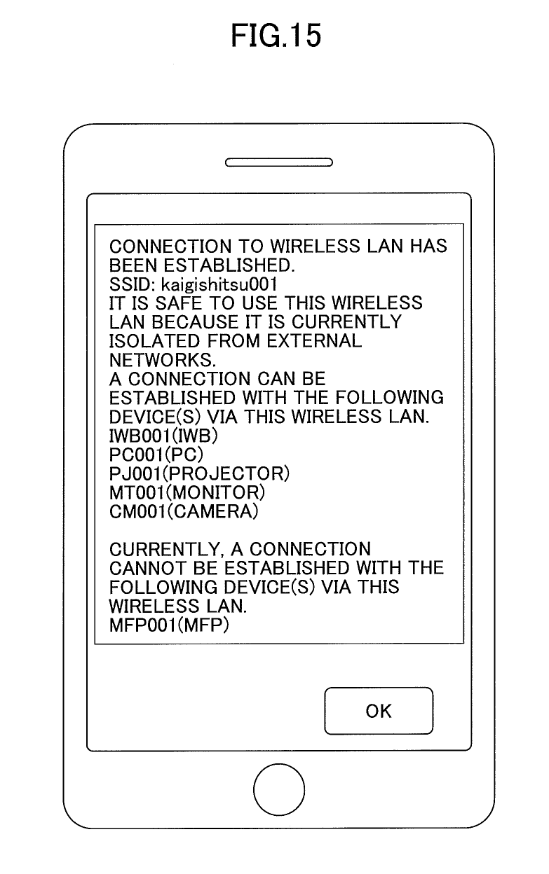

Next, referring to FIG. 15, a display screen that may be displayed by the terminal 20 when the terminal 20 establishes wireless communication with the relay apparatus 10 in step S409 of FIG. 13 is described. Such a display screen may be displayed by the terminal 20 based on a notification transmitted from the relay apparatus 10 when the wireless communication between the terminal 20 and the relay apparatus 10 has been established, for example.

FIG. 15 illustrates an example display screen that may be displayed by the terminal 20 that has established wireless communication with the relay apparatus 10 according to the third embodiment of the present invention. The relay apparatus 10 may transmit to the terminal 20 a notification indicating that the wireless communication has been established, and indicating the information processing apparatus 30-2 that can be accessed via the internal network and the information processing apparatus 30-1 that is disconnected from the internal network and cannot be accessed via the internal network, for example. The relay apparatus 10 may further control the terminal 20 to display the display screen of FIG. 15, for example.

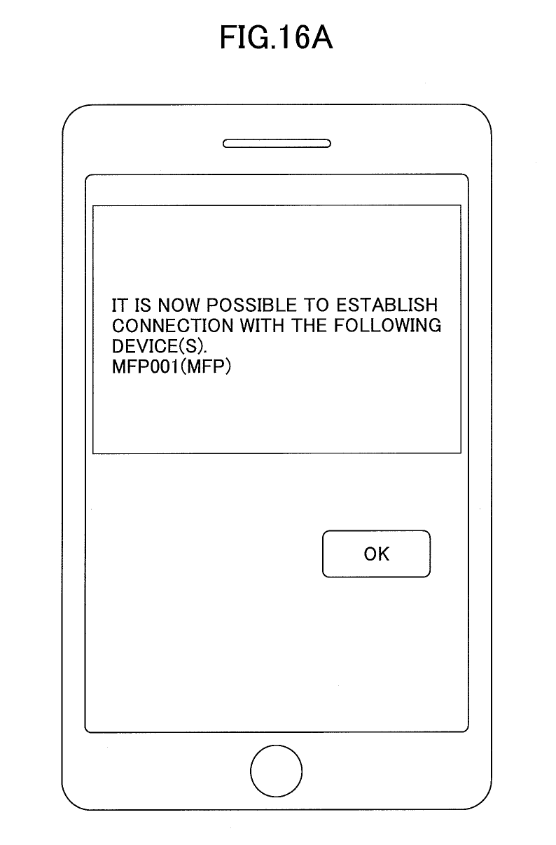

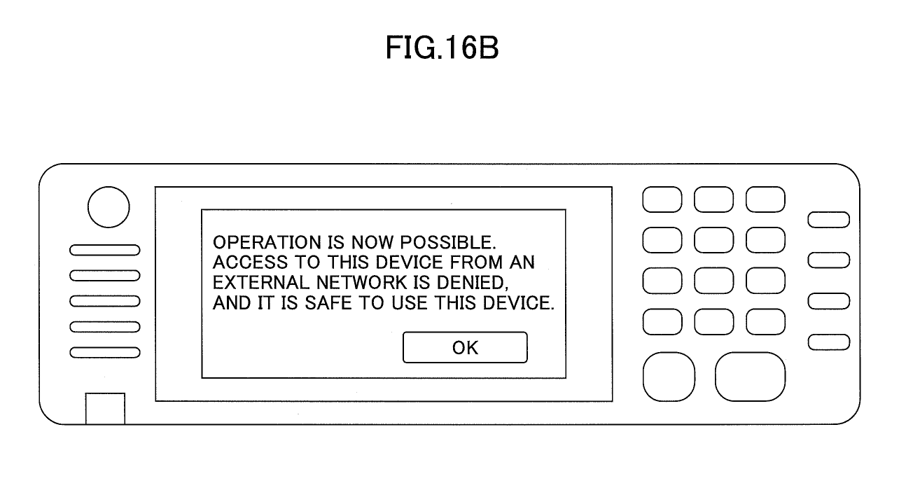

Next, referring to FIGS. 16A and 16B, display screens that may be displayed by the information processing apparatus 30-1 and the terminal 20 when communication between the information processing apparatus 30-1 and the external network has ended in step S422 of FIG. 13 are described. Such display screens may be displayed by the information processing apparatus 30-1 and the terminal 20 based on a notification transmitted from the relay apparatus 10 when the communication with the external network has ended, for example.

FIGS. 16A and 16B respectively illustrate example display screens that may be displayed by the information processing apparatus 30-1 and the terminal 20 when communication between the information processing apparatus 30-1 and the external network has ended. When the communication between the information processing apparatus 30-1 and the external network ends and the information processing apparatus 30-1 establishes connection with the internal network, the relay apparatus 10 may transmit a notification to the terminal 20 and the information processing apparatus 30-1 indicating that communication between the information processing apparatus 30-1 and the external network is prohibited and communication between the terminal 20 and the information processing apparatus 30-1 is allowed. In turn, the terminal 20 and the information processing apparatus 30-1 may respectively display the display screens of FIGS. 16A and 16B, for example.

In the process operations according to the third embodiment, whether to allow or prohibit communication with the external network is determined based on information on the information processing apparatuses 30 included in the internal network. In this way, whether to allow or prohibit communication with the external network may be more aptly controlled, for example.

### Example Modifications

In some embodiments, the relay apparatus 10 may manage an access log that records information on requests for access to the information processing apparatus 30 from the external apparatus 40, and the relay apparatus 10 may control whether to allow or prohibit communication with the external network via the communication unit 13 based on the information recorded in the access log. For example, when a process request addressed to the information processing apparatus 30-1 that is transmitted from the external apparatus 40 is rejected, the time at which communication was rejected may be recorded in the access log in association with an ID (e.g., IP address) of the external apparatus 40 and an ID of the information processing apparatus 30-1, for example. In this way, when the communication unit 13 receives a process request addressed to the information processing apparatus 30-1 from the external apparatus 40, the control unit 15 may refer to the access log to determine whether the process request addressed to the information processing apparatus 30-1 has been continuously rejected for at least a predetermine time period, and if the process request has been rejected for at least the predetermined time period, the control unit 15 may disconnect the information processing apparatus 30-1 from the internal network. In this way, when attempts to access the information processing apparatus 30-1 from the external network for purposes administering maintenance such as updates have continuously failed for at least a predetermined time period, communication for administering maintenance may be prioritized, for example.

Also, in some embodiments, the relay apparatus 10 may determine the importance of a request for access to the information processing apparatus 30 from the external apparatus 40 and control whether to allow or prohibit communication with the external network via the communication unit 13 based on the importance of the access request. For example, in transmitting a process request addressed to the information processing apparatus 30-1, the external apparatus 40 may attach importance information indicating the importance of the process request. In turn, when the communication unit 13 receives the process request addressed to the information processing apparatus 30-1 from the external apparatus 40, the control unit 15 may determine the importance of the process request, and if the importance exceeds a predetermined value, the control unit 15 may disconnect the information processing apparatus 30-1 from the internal network. In this way, for example, when a process request is for administering updates to fix a serious security issue at the information processing apparatus 30-1, communication for administering maintenance may be prioritized.

Note that the various notifications transmitted from the relay apparatus 10 to the terminal 20 may be transmitted using the wireless communication unit 12 or the short-range wireless communication unit 11, for example.

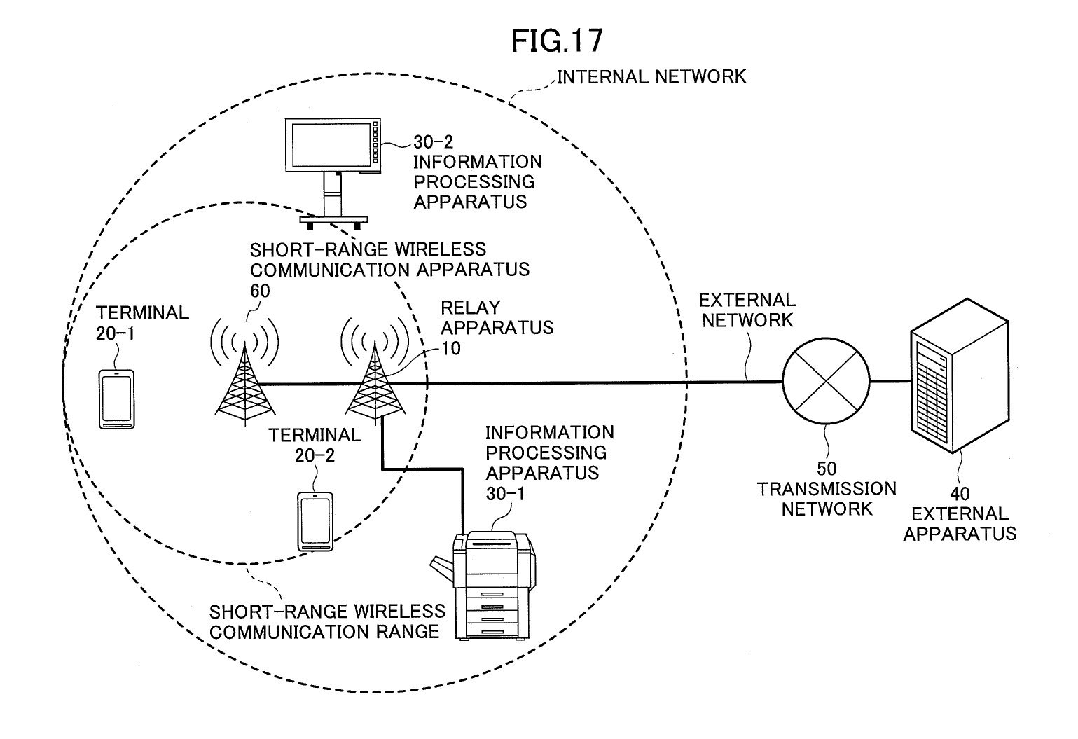

Also, in some embodiments, the short-range wireless communication unit 11 may be implemented an apparatus that is separate from the relay apparatus 10 as illustrated in FIG. 17, for example. FIG. 17 is a diagram illustrating another general arrangement of the communication system 1 in which the wireless communication unit 11 is implemented by a short-range wireless communication apparatus 60. In the example of FIG. 17, the relay apparatus 10 and the information processing apparatus 30-1 are connected to each other by a wired LAN cable. The short-range wireless communication apparatus 60 controls the short-range wireless I/F 104 to determine whether the terminal 20 is within its communication range using short-range wireless technology, such as BLE, NFC, or wireless LAN, and notifies the relay apparatus 10 of the determination result. The relay apparatus 10 obtains from the short-range wireless communication apparatus 60 information on the terminal 20 that is capable of establishing short-range wireless communication with the short-range wireless communication apparatus 60. Then, as with the relay apparatus 10 according to the first through third embodiments as described above, the relay apparatus 10 may prohibit communication between the external network and the information processing apparatus 30 connected to the internal network while the short-range wireless communication apparatus 60 detects the terminal 20 within its communication range, for example. In this system configuration, for example, the short-range wireless communication apparatus 60 may be placed near an entrance/exit of a conference room while the relay apparatus 10 may be placed around the center of the conference room.

Note that the system configuration described above is merely one example, and embodiments of the present invention encompass various other system configurations.

Although the present invention has been described above with reference to certain illustrative embodiments, the present invention is not limited to these embodiments, and numerous variations and modifications may be made without departing from the scope of the present invention.

What is claimed is:

1. A relay apparatus that relays communication between an internal network and an external network, the relay apparatus comprising:
a short-range wireless communication unit configured to detect a terminal by establishing short-range wireless communication with the terminal;
a first communication unit configured to establish connection with an information processing apparatus that is included in the internal network;
a second communication unit configured to establish connection with the external network; and
a control unit configured to prohibit communication between the information processing apparatus and the external network while the terminal is being detected by the short-range wireless communication.

2. The relay apparatus according to claim 1, wherein
when the control unit prohibits the communication between the information processing apparatus and the external network, the control unit transmits a notification to the terminal indicating that the communication between the information processing apparatus and the external network is prohibited.

3. The relay apparatus according to claim 1, wherein
when the terminal is no longer detected by the short-range wireless communication, the control unit allows the communication between the information processing apparatus and the external network.

4. The relay apparatus according to claim 3, wherein
when the terminal is no longer detected by the short-range wireless communication, the control unit requests the information processing apparatus to delete confidential information that has been generated at the information processing apparatus while the terminal has been detected by the short-range wireless communication.

5. The relay apparatus according to claim 1, wherein
when the terminal is no longer detected by the short-range wireless communication, the control unit requests the information processing apparatus to delete confidential information that has been generated at the information processing apparatus while the terminal has been detected by the short-range wireless communication; and
when the control unit receives from the information processing apparatus a notification that the confidential information has been deleted, the control unit allows the communication between the information processing apparatus and the external network.

6. The relay apparatus according to claim 1, wherein
in a case where a first information processing apparatus is communicating with the external network when the terminal is detected by the short-range wireless communication, the control unit allows communication between the first information processing apparatus and the external network, and prohibits communication between the first information processing apparatus and a second information processing apparatus that is connected to the first information processing apparatus.

7. The relay apparatus according to claim 6, wherein
when the control unit prohibits the communication between the first information processing apparatus and the second information processing apparatus, the control unit transmits a notification to at least one of the terminal and the first information processing apparatus indicating that the communication between the first information processing apparatus and the second information processing apparatus is prohibited.

8. The relay apparatus according to claim 6, wherein
when the control unit detects that the communication between the first information processing apparatus and the external network has ended, the control unit prohibits the communication between the first information processing apparatus and the external network, and allows the communication between the first information processing apparatus and the second information processing apparatus that is connected to the first information processing apparatus.

9. The relay apparatus according to claim 1, wherein
when the terminal is detected by the short-range wireless communication, the control unit determines whether to allow or prohibit the communication between the information processing apparatus and the external network based on at least one of a number of terminals detected by the short-range wireless communication, an attribute of the terminal, a type of the information processing apparatus, a length of a period during which the terminal is detected by the short-range wireless communication, and an importance of a request for access to the information processing apparatus from the external network.

10. A communication control method implemented by a relay apparatus that relays communication between an internal network and an external network, the communication control method comprising:
detecting a terminal by establishing short-range wireless communication with the terminal; and
prohibiting communication between the external network and an information processing apparatus that is included in the internal network while the terminal is detected by the short-range wireless communication.

11. A communication control system comprising:
a short-range wireless communication apparatus; and
a relay apparatus that relays communication between an internal network and an external network;
wherein the short-range wireless communication apparatus detects a terminal by establishing wireless communication with the terminal; and
wherein the relay apparatus includes
a first communication unit configured to establish connection with the information processing apparatus that is included in the internal network;
a second communication unit configured to establish connection with the external network; and
a control unit configured to prohibit communication between the information processing apparatus and the external network while the terminal is detected by the short-range wireless communication apparatus.

12. The communication control system according to claim 11, wherein
when the control unit prohibits the communication between the information processing apparatus and the external network, the control unit transmits a notification to the terminal indicating that the communication between the information processing apparatus and the external network is prohibited.

13. The communication control system according to claim 11, wherein
when the terminal is no longer detected by the short-range wireless communication apparatus, the control unit allows the communication between the information processing apparatus and the external network.

14. The communication control system according to claim 13, wherein
when the terminal is no longer detected by the short-range wireless communication apparatus, the control unit requests the information processing apparatus to delete confidential information that has been generated at the information processing apparatus while the terminal has been detected by the short-range wireless communication apparatus.

15. The communication control system according to claim 11, wherein
when the terminal is no longer detected by the short-range wireless communication apparatus, the control unit requests the information processing apparatus to delete confidential information that has been generated at the information processing apparatus while the terminal has been detected by the short-range wireless communication apparatus; and
when the control unit receives from the information processing apparatus a notification that the confidential information has been deleted, the control unit allows the communication between the information processing apparatus and the external network.

16. The communication control system according to claim 11, wherein
in a case where a first information processing apparatus is communicating with the external network when the terminal is detected by the short-range wireless communication apparatus, the control unit allows communication between the first information processing apparatus and the external network, and prohibits communication between the first information processing apparatus and a second information processing apparatus that is connected to the first information processing apparatus.

17. The communication control system according to claim 16, wherein
when the control unit prohibits the communication between the first information processing apparatus and the second information processing apparatus, the control unit transmits a notification to at least one of the terminal and the first information processing apparatus indicating that the communication between the first information processing apparatus and the second information processing apparatus is prohibited.

18. The communication control system according to claim 16, wherein
when the control unit detects that the communication between the first information processing apparatus and the external network has ended, the control unit prohibits the communication between the first information processing apparatus and the external network, and allows the communication between the first information processing apparatus and the second information processing apparatus that is connected to the first information processing apparatus.

19. The communication control system according to claim 11, wherein
when the terminal is detected by the short-range wireless communication apparatus, the control unit determines whether to allow or prohibit the communication between the information processing apparatus and the external network based on at least one of a number of terminals detected by the short-range wireless communication apparatus, an attribute of the terminal, a type of the information processing apparatus, a length of a period during which the terminal is detected by the short-range wireless communication apparatus, and an importance of a request for access to the information processing apparatus from the external network.
